(19) United States
(12) Patent Application Publication
(10) Pub. No.: US 2024/0052442 A1
(43) Pub. Date: Feb. 15, 2024

(54) STEEL PRODUCTION FROM IRON MELT

(71) Applicant: Primetals Technologies Austria GmbH, Linz (AT)

(72) Inventors: Robert MILLNER, Loosdorf (AT); Norbert REIN, Wien (AT); Johann WURM, Bad Zell (AT)

(21) Appl. No.: 18/250,928

(22) PCT Filed: Oct. 28, 2021
(86) PCT No.: PCT/EP2021/079977

§ 371 Date: Apr. 27, 2023

(30) Foreign Application Priority Data
Oct. 30, 2020 (EP) 20204857.5

(51) Int. Cl. C21B 13/14; C21B 13/00; C21C 5/52

(52) U.S. Cl. CPC C21B 13/14; C21B 13/0073; C21C 5/5205

(57) ABSTRACT

A process for steel production that includes:
production of sponge iron from iron oxide-containing starting material by direct reduction with reduction gas, wherein the reduction gas has at least 20% by volume of hydrogen H₂,
and production of an iron melt having a carbon content of 1-5% by mass from the sponge iron.

Sponge iron is subjected to a treatment that includes:
energy input and addition of additives to produce a melt and a slag, wherein the energy input is effected substantially from electricity and wherein the slag has a basicity B2 of less than 1.3, preferably less than 1.25, particularly preferably less than 1.2,
adjustment of the carbon content in the melt,
reduction of at least a sub-amount of the iron oxides present in the sponge iron

The slag is separated during and/or after the treatment.

### TECHNICAL FIELD

Invention relates to a process for steel production comprising production of an iron melt using sponge iron obtained by direct reduction with reduction gas.

### PRIOR ART

The majority of current steel production is carried out by the blast furnace route with subsequent steel production based on the basic oxygen process (LD/BOF). This route makes it possible to process a broad spectrum of iron ores since gangue fractions in the form of slag can be discharged with low iron losses in the blast furnace and the downstream BOF makes it possible to produce high-quality, universally employable raw steel.

A smaller proportion of steel production is based on direct reduction using reduction gas to afford sponge iron, also known as direct reduced iron (DRI), with subsequent steel production using an electric arc furnace (EAF). Compared to the blast furnace route it is necessary to use higher quality raw materials having a lower gangue fraction in order to limit slag quantities/iron losses and energy and raw material costs generated in a conventional EAF. A conventional EAF also requires a high degree of metallization of the sponge iron. As a consequence of the process the raw steel quality is also lower or costly aftertreatments of the raw steel obtained in the EAF must be performed to achieve comparable steel qualities.

To reduce industrial CO2 emissions a reduction in the proportion of worldwide steel production proceeding by the blast furnace route is desired, since said route is based on the use of coal or coke. Increasing the proportion of worldwide steel production proceeding by direct reduction is a possible means of compensation since production thereby can also proceed in ways that entail lower CO2 emissions, for example using reduction gas based on natural gas or hydrogen. However, the disadvantages associated with this route compared to the blast furnace route limit the potential for diverting steel production towards direct reduction.

### SUMMARY OF THE INVENTION

### Technical Problem

The problem addressed by the present invention is that of specifying a process and apparatus which makes it possible to avoid the abovementioned disadvantages or to at least reduce the extent thereof.

### Technical Solution

This problem is solved by a process for steel production comprising
production of sponge iron from iron oxide-containing starting material by direct reduction with reduction gas, wherein the reduction gas comprises at least 20% by volume of hydrogen H2, and
production of an iron melt having a carbon content of 1-5% by mass, wherein at least a sub-amount of the sponge iron produced from iron oxide-containing starting material by direct reduction with reduction gas is subjected to a treatment,
   wherein the treatment comprises:
energy input and addition of additives to produce a melt and a slag, wherein the energy input is effected substantially from electricity and wherein the slag has a basicity B2 of less than 1.3, preferably less than 1.25, particularly preferably less than 1.2,
adjustment of the carbon content in the melt,
reduction of at least a sub-amount of the iron oxides present in the sponge iron
   and wherein the slag is separated during and/or after the treatment
   and
use of the iron melt for production of steel.

The process comprises direct reduction which is carried out using a reduction gas which comprises 20% by volume of hydrogen. This allows steel production to proceed with a lower CO2 burden than when the arc furnace route for reducing iron oxide-containing starting material is used or direct reduction is performed with a lower hydrogen fraction. The direct reduction is carried out without addition of solid carbon or solid carbon-containing substances as reductant.

The direct reduction is carried out in a direct reduction reactor which may be configured for example as a fixed bed reactor or fluidized bed reactor or moving bed reactor.

The higher the hydrogen proportion in the reduction gas of the direct reduction, the lower the carbon content in the sponge iron.

This affects the temperature range of the melting during the treatment. This also affects the amount of the carbon-containing emissions occurring during steel production according to the process and can affect the carbon content of the steel produced.

The treatment of the process according to the invention is a bath process, not a fixed bed process. It serves to produce a product which is like the product of a blast furnace—liquid pig iron—on the basis of sponge iron from a direct reduction process. This liquid product shall have a carbon content between 1-5% by mass inclusive. Percent by mass or % by mass refer to the mass fraction.

To this end energy is supplied and additives are added to the sponge iron, thus resulting in formation of a melt based on the iron and in formation of a slag based on the gangue of the underlying ore present in the sponge iron. Additives include for example limestone and/or dolomite, both of which may be uncalcined or—preferably—calcined, and quartz. The slag has a basicity B2 of less than 1.3, preferably less than 1.25, particularly preferably less than 1.2. Such a slag is like the slag of a blast furnace and may be utilized accordingly, for example in the cement industry. The lower the basicity, the smaller the slag quantity generated, thus also making operation of the process according to the invention more energetically favorable.

The basicity B2 is the ratio of calcium oxide to silicon dioxide CaO/SiO₂ in percent by mass.

In the production of the iron melt sponge iron is subjected to a treatment.

The employed source of the iron in the iron melt may be sponge iron in conjunction with other iron carriers—for example scrap or pig iron—or solely sponge iron may be used as a source of the iron in the iron melt.

The carbon content of the melt is adjusted to the desired level—the iron melt resulting from the process shall have a carbon content of 1-5% by mass and the adjustment is carried out accordingly; for example through supply of carbon-carriers into the melt and/or through supply of means for reducing the carbon content in the melt, for example oxygen.

The treatment also comprises reduction of at least a sub-amount of the iron oxides present in the sponge iron, with the result that the amount of metallic iron in the melt is greater than that in the sponge iron from which it is derived; this occurs during and/or after the energy input.

The energy input is effected substantially from electricity. This is essentially to be understood as meaning at least more than 50% of the supplied energy, preferably more than 65% of the supplied entity, particularly preferably more than 80% of the supplied energy.

Especially due to the increasing proportion of electricity from generation from renewable energy sources this improves the CO2 balance of the process and of a steel produced on the basis of the liquid pig iron-like product.

In the blast furnace route slag generated is separated from the pig iron, for example when the pig iron and the slag are tapped and undergo gravity-assisted separation as a result of their mutual insolubility and differing density. As claimed, the slag is separated during and/or after the treatment. The melt is obtained as a liquid, pig iron-like product having a carbon content of 1% by mass to 5% by mass. The removal of the slag is carried out for example by tipping it out. Separating the slag, which is derived from the gangue present in the sponge iron and the additives, removes the gangue present in the iron oxide-containing starting material.

The iron melt produced according to the invention having a carbon content of 1.0% by mass to 5% by mass consists predominantly of iron—it is a liquid, pig iron-like product; the expression liquid, pig iron-like product is in the present application used synonymously with the expression iron melt to refer to the iron melt produced according to the invention. The liquid, pig iron-like product having a carbon content of 1.0% by mass to 5% by mass is from the perspective of a steel production process—for example LD/BOF—“like” a pig iron from a blast furnace, that is to say it is processable in largely the same way as pig iron from a blast furnace, i.e. according to the blast furnace route of steel production with the exception of the blast furnace. The higher the carbon content the more cooling scrap may be employed in the subsequent processing into steel; a higher amount of cooling scrap reduces the CO2 emissions per quantity unit of a steel produced from liquid, pig iron-like product produced according to the invention.

The carbon content of the liquid, pig iron-like product is preferably at least 1.25% by mass, particularly preferably at least 1.5% by mass. It is preferable when the carbon content of the liquid, pig iron-like product is up to 4% by mass, particularly preferably up to 3.5% by mass, very particularly preferably up to 3% by mass.

When performing the process according to the invention it may be advantageous to charge the sponge iron into a vessel in which a small amount of an iron melt is already present as a liquid pool; this liquid pool may for example be retained in the vessel upon emptying the vessel after a preceding use of the process according to the invention but may also originate from another source, for example pig iron originating from a blast furnace for example.

### Advantageous Effects of the Invention

The invention makes it possible to achieve efficient and economic industrial production of steel from sponge iron without utilizing conventional EAF operations. The routes of steel production known for pig iron may be utilized.

Conventional EAF operations for steel production are operated under oxidizing conditions to reduce the carbon level with high temperature and high basicity. A high degree of metallization and a low proportion of gangue in the sponge iron are necessary to minimize iron losses through iron oxides in the slag. It is therefore necessary to use high-quality iron carriers in the production of the sponge iron to be supplied to conventional EAF operations—high-quality is to be understood as meaning that little gangue is present in the iron carriers; the less gangue is introduced into the EAF via the sponge iron, the lower the slag quantity in the EAF. The lower the slag quantity, the less iron can be lost in the slag as iron oxide. The higher the degree of metallization, the lower the amount of iron oxides present in the sponge iron, thus correspondingly reducing the risk of loss of iron oxides through slag.

Carbon is present in the process sequence according to the invention; thus at least a sub-amount of the iron oxides present in the sponge iron may be reduced by carbon, thus also allowing the employed sponge iron to have a lower metallization compared to conventional EAF operations. Due to the reduction of iron oxide the iron losses via iron oxide fractions in the slag are lower compared to processing of sponge iron in a conventional EAF.

The presence of carbon in the melt also reduces the temperature range of the melting operation, i.e. the temperature range in which the pig iron-like product is converted from the solid state of matter into the liquid state of matter, thus requiring less energy input for liquefaction. This means that steel production from sponge iron utilizing the process according to the invention entails comparatively lower energy costs than conventional EAF operations.

The production of the pig iron-like product does not require the basicity of the slag to be as high as in conventional EAF operations since, unlike in the case of conventional EAF operations, the process is not focused on the production of steel. Accordingly, steel production from sponge iron utilizing the process according to the invention also generates less slag than in the case of conventional EAF operations or sponge iron having a higher proportion of gangue from lower quality raw materials may be processed at comparable slag quantity compared to conventional EAF operations. The lower slag quantity compared to the conventional EAF route also derives from the fact that the procedure according to the invention is performed with a lower basicity of the slag and thus a lower amount of additives since, compared to the EAF route, there is a greater focus on removal of the gangue rather than enhancement of steel quality. A lower slag quantity also entails a lower energy demand for heating/melting, since less material needs to be heated. The process according to the invention is preferably operated at a basicity B2 below 1.3, particularly preferably at a basicity B2 below 1.25, very particularly preferably at a basicity B2 below 1.2.

The process according to the invention may be utilized to process a broad spectrum of iron ores since gangue fractions are already discharged as slag with low iron losses upon production of the liquid pig iron-like product having a carbon content of 1.0% to 5%. The steps processing the liquid pig iron-like product during steel production are thus not burdened with the slag that has already been removed. By contrast, conventional EAF operations processing sponge iron are burdened with markedly greater slag quantities.

Since from the perspective of a steel production process—for example LD/BOF—the liquid, pig iron-like product having a carbon content of 1.0% by mass to 5% by mass can be processed in largely the same way as pig iron from a blast furnace it is possible to produce steel with corresponding qualities and universal potential applications; limitations in this regard from the use of a conventional EAF route can thus be overcome and/or costly aftertreatments can be omitted.

In a preferred embodiment of the process the direct reduction is performed using a reduction gas comprising more than 45% by volume of hydrogen H2.

The greater the proportion of hydrogen, the lower the CO2 balance of the process according to the invention or a steel produced on the basis of the liquid, pig iron-like product.

In an advantageous embodiment the direct reduction is carried out in a direct reduction reactor and the treatment is carried out in a treatment reactor, wherein the direct reduction reactor and the treatment reactor are spatially separate from one another. A transport apparatus may be used to transport the sponge iron from the direct reduction reactor to the treatment reactor.

An arrangement of the direct reduction reactor and the treatment reactor in a common apparatus, i.e. not spatially separate from one another but directly adjacent, is likewise possible.

In an advantageous embodiment the energy input is effected via an electric arc.

In an advantageous embodiment the energy input is effected via electric resistance heating. This may be the performance of an electrolysis for example.

In an advantageous embodiment the energy input is effected via a hydrogen plasma produced using electricity.

In an advantageous embodiment the energy input is effected partly via introduction of oxygen for gasification of carbon supplied to the melt in the solid or liquid state or of carbon dissolved in the melt. In practice this is effected for example via burners or using lances.

It is preferable to introduce oxygen which is at least of technical purity.

In an advantageous embodiment the adjustment of the carbon content in the melt is effected using supplied carbon carriers.

These may be solid carbon carriers and/or liquid carbon carriers and/or gaseous carbon carriers. The carbon carriers may comprise for example coal dust, coke breeze, graphite dust or natural gas. The carbon carriers may also derive partly or entirely from carbon-neutral sources, for example from biomass, for instance charcoal; this improves the CO2 balance of the process. The carbon carriers may be introduced for example via lances or under-bath nozzles.

In an advantageous embodiment the adjustment of the carbon content in the melt is effected using supplied oxygen. If the carbon content is above the desired value for the iron melt, oxygen supply may be used to achieve oxidative attenuation of the carbon content, for example carbon in the melt can react to afford CO and escape from the melt in gaseous form.

In an advantageous embodiment the reduction of at least a sub-amount of the iron oxides present in the sponge iron is effected using supplied carbon carriers.

These may be solid carbon carriers and/or liquid carbon carriers and/or gaseous carbon carriers. The carbon carriers may comprise for example coal dust, coke breeze, graphite dust or natural gas. The carbon carriers may also derive partly or entirely from carbon-neutral sources, for example from biomass, for instance charcoal; this improves the CO2 balance of the process.

In an advantageous embodiment the reduction of at least a sub-amount of the iron oxides present in the sponge iron is effected using carbon present in the sponge iron.

In sponge iron carbon may be bound and/or dissolved for example in the form of cementite (Fe3C) and/or be present in the form of elemental carbon.

In an advantageous embodiment the reduction of at least a sub-amount of the iron oxides present in the sponge iron is effected at least partly using electric current.

This may be effected for example using electrolysis or using hydrogen plasma.

In an advantageous embodiment the treatment effects a lowering of the melting range using supplied solid carbon carriers and/or liquid carbon carriers and/or gaseous carbon carriers. These are for example coal dust, coke breeze, graphite dust or natural gas. The carbon carriers may also derive partly or entirely from carbon-neutral sources, for example from biomass, for instance charcoal; this improves the CO2 balance of the process. Lowering is to be understood in comparison to the melting point of iron. The process according to the invention is preferably operated below a temperature of 1550° C., preferably below a temperature of 1500° C., particularly preferably below a temperature of 1450° C.

In an advantageous embodiment the production of steel employs the LD/BOF process.

This is preferably carried out with a scrap usage of at least 10% by mass, preferably at least 15% by mass, particularly preferably at least 20% by mass.

The present application further provides a signal processing means with a machine-readable program code comprising control commands for performing the process according to the invention. The present application further provides a machine-readable program code for such a signal processing means, wherein the program code comprises control commands which prompt the signal processing means to perform a process according to the invention. The present invention further provides a storage medium having a machine-readable program code of this kind stored thereupon.

### BRIEF DESCRIPTION OF THE DRAWINGS

The invention will now be more particularly elucidated with reference to exemplary embodiments. The drawing is exemplary and is intended to illustrate the inventive concept but is in no way intended to be limiting, let alone provide an exhaustive illustration thereof.

FIG. 1 shows:

a schematic representation of a process sequence according to the invention.

### BRIEF DESCRIPTION OF THE EMBODIMENTS

### Examples

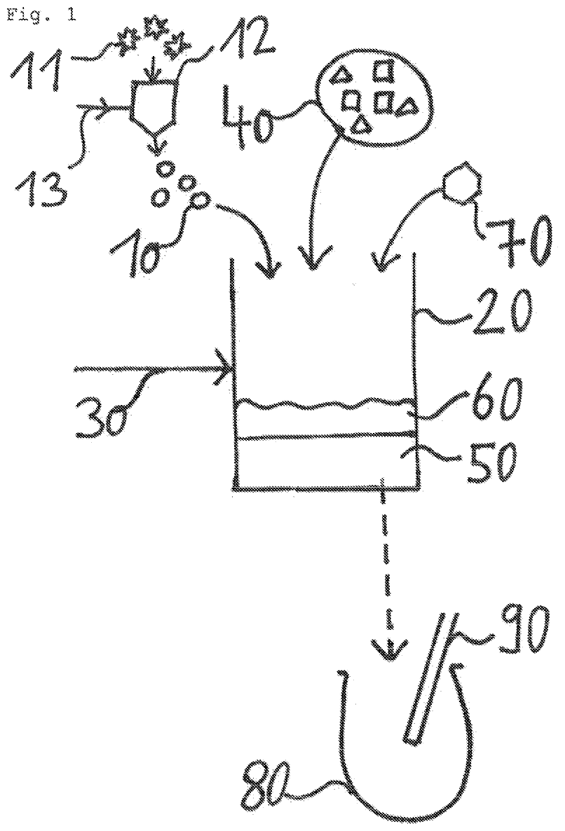

FIG. 1 is a schematic presentation of the inventive process sequence for producing an iron melt.

Sponge iron 10 is produced from iron oxide-containing starting material 11 by direct reduction in a direct reduction reactor 12 with reduction gas 13. The reduction gas 13 comprises at least 20% by volume of hydrogen H2. Sponge iron 10 is supplied to a treatment reactor 20. In the treatment reactor 20 it is subjected to a treatment. The treatment comprises energy input represented by arrow 30. The energy input is effected substantially from electricity.

The treatment comprises addition of additives 40.

The treatment produces a melt 50 and a slag 60. The slag has a basicity B2 of less than 1.3.

The treatment comprises adjusting the carbon content in the melt 50; represented by way of example by addition of carbon carriers 70.

The treatment comprises reduction of at least a sub-amount of the iron oxides present in the sponge iron 10.

The slag 60 is separated during and/or after the treatment (not shown). The melt 50 is the iron melt sought having a carbon content of 1-5% by mass. Said melt may for example be supplied by blowing lance 90 to a converter 80 for producing steel by the LD process as indicated by the dashed arrow.

The sponge iron 10 is obtained from iron oxide-containing starting material by direct reduction with reduction gas; the reduction gas may comprise at least 20% by volume of hydrogen H2.

The direct reduction is carried out in a direct reduction reactor and the treatment is carried out in a treatment reactor 20. The direct reduction reactor and the treatment reactor 20 may be spatially separate from one another, wherein the sponge iron may be transported from the direct reduction reactor to the treatment reactor using a transport apparatus.

An arrangement of the direct reduction reactor and the treatment reactor 20 in a common apparatus, i.e. not spatially separate from one another but directly adjacent, is likewise possible.

### LIST OF REFERENCE NUMERALS

10 Sponge iron
11 Iron oxide-containing starting material.
12 Direct reduction reactor
13 Reduction gas
20 Treatment reactor
30 Energy input
40 Additives
50 Melt
60 Slag
70 Carbon carrier
80 Converter
90 Blowing lance

1. A process for steel production comprising
production of sponge iron from iron oxide-containing starting material by direct reduction with reduction gas, wherein the reduction gas comprises at least 20% by volume of hydrogen H2,
and
production of an iron melt having a carbon content of 1-5% by mass, wherein at least a sub-amount of the sponge iron produced from iron oxide-containing starting material by direct reduction with reduction gas is subjected to a treatment,
wherein the treatment comprises:
energy input and addition of additives to produce a melt and a slag wherein the energy input is effected substantially from electricity and wherein the slag has a basicity B2 of less than 1.3, preferably less than 1.25, particularly preferably less than 1.2,
adjustment of the carbon content in the melt,
reduction of at least a sub-amount of the iron oxides present in the sponge iron and wherein the slag is separated during and/or after the treatment
and
use of the iron melt for production of steel.

2. The process as claimed in claim 1, wherein the direct reduction is performed using a reduction gas comprising more than 45% by volume of hydrogen H2.

3. The process as claimed in claim 1, wherein the direct reduction is carried out in a direct reduction reactor the treatment is carried out in a treatment reactor and the direct reduction reactor and the treatment reactor are spatially separate from one another.

4. The process as claimed in claim 1, wherein the energy input is effected via an electric arc.

5. The process as claimed in claim 1, wherein the energy input is effected via electric resistance heating.

6. The process as claimed in claim 1, wherein the energy input is effected via a hydrogen plasma produced using electricity.

7. The process as claimed in claim 1, wherein the energy input is effected partly via introduction of oxygen
for gasification of carbon supplied to the melt in the solid or liquid state or of carbon dissolved in the melt.

8. The process as claimed in claim 1, wherein
the adjustment of the carbon content in the melt is effected using supplied carbon carriers.

9. The process as claimed in claim 1, wherein
the adjustment of the carbon content in the melt is effected using supplied oxygen.

10. The process as claimed in claim 1, wherein the reduction of at least a sub-amount of the iron oxides present in the sponge iron is effected using supplied carbon carriers.

11. The process as claimed in claim 1, wherein the reduction of at least a sub-amount of the iron oxides present in the sponge iron is effected using carbon present in the sponge iron.

12. The process as claimed in claim 1, wherein the reduction of at least a sub-amount of the iron oxides present in the sponge iron is effected at least partly using electric current.

13. The process as claimed in claim 1, wherein the treatment effects a lowering of the melting range using supplied solid carbon carriers and/or liquid carbon carriers and/or gaseous carbon carriers.

14. The process as claimed in claim 1, wherein the production of steel employs the LD/BOF process.
